(19) United States
(12) Patent Application Publication
(10) Pub. No.: US 2003/0040459 A1
(43) Pub. Date: Feb. 27, 2003

(54) Cleaning compositions

(75) Inventors: Abraham Araya, Wirral (GB); Jelles Vincent Boskamp, Vlaardingen (NL); Ian Callaghan, Vlaardingen (NL); Somdath Choennie, Vlaardingen (NL); Mark Antony Woodhouse, Warrington (GB)

Correspondence Address: PILLSBURY WINTHROP, LLP, P.O. BOX 10500, MCLEAN, VA, 22102, US

(73) Assignee: Unilever Home & Pesonal Care USA, Greenwich, CT (US)

(21) Appl. No.: 10/057,908

(22) Filed: Jan. 29, 2002

(30) Foreign Application Priority Data
Feb. 5, 2001 (EP) 01301011.1
Feb. 5, 2001 (GB) 0102736.6

(51) Int. Cl. C11D 17/00

(52) U.S. Cl. 510/446; 510/507

(57) ABSTRACT

The invention provides disintegrant granules and a tablet of compacted particulate detergent composition comprising non-soap surfactant and detergency builder, wherein the tablet or a discrete region thereof comprises disintegrant granules comprising a water-swelling clay, a water-insoluble inorganic material and a water-swellable agent. The inorganic material is preferably silica or a crystalline aluminosilicate. The tablets show good disintegration properties, even upon storage. Especially good disintegration is obtained for tablets comprising disintegrant granules which comprise the water-swellable agent, which in its anhydrous state, comprises no more than 20% by weight of the combined weight of the swelling clay, the inorganic material and the water-swellable agent. A method of making the tablets is also provided.

### FIELD OF THE INVENTION

The present invention relates to disintegrant granules and to cleaning compositions in the form of tablets, comprising said granules. These tablets are intended to disintegrate when placed in water and thus are intended to be consumed in a single use. The tablets may be suitable for use in machine dishwashing, the washing of fabrics or other cleaning tasks.

### BACKGROUND OF THE INVENTION

Products in tablet form have several advantages over powdered products: for example, they do not require measuring and are thus easier to handle and dispense into the wash-load, and they are more compact, hence facilitating more economical storage.

Detergent compositions in tablet form and intended for fabric washing have been described in a number of patent documents including, for example GB 911 204, EP-A-711827, WO-98/42817, U.S. Pat. No. 5,360,567 and WO-99/20730 (all Unilever), U.S. Pat. No. 3,953,350 (Kao), DE 19 637 606 (Henkel) and are now sold commercially. Tablets of composition suitable for machine dishwashing have been disclosed in EP-A-318204, WO96/23530 and U.S. Pat. No. 5,691,293 and are sold commercially.

Tablets of a cleaning composition are generally made by compressing or compacting a composition in particulate form. Although it is desirable that tablets have adequate strength when dry, yet disperse and dissolve quickly when brought into contact with water, it can be difficult to obtain both properties together. Tablets formed using a low compaction pressure tend to crumble and disintegrate on handling and packing; while more forcefully compacted tablets may be sufficiently cohesive but then fail to disintegrate or disperse to an adequate extent in the wash. Tabletting will often be carried out with enough pressure to achieve a compromise between these desirable but antagonistic properties. However, it remains desirable to improve one or other of these properties without detriment to the other so as to improve the overall compromise between them. U.S. Pat. No. 3,018,267 (Procter & Gamble) taught that the force, and hence pressure, applied when compacting a composition into tablets should be limited, or else the tablets would take too long to dissolve.

If a tablet contains organic surfactant, this can function as a binder, plasticising the tablet. However, it can also retard disintegration of the tablet by forming a viscous gel when the tablet comes into contact with water. Thus, the presence of surfactant can make it more difficult to achieve both good strength and speed of disintegration: the problem has proved especially acute with tablets formed by compressing powders containing surfactant and built with insoluble detergency builder such as sodium aluminosilicate (zeolite).

It is known to include highly soluble materials whose function is to enhance disintegration of tablets when placed in wash water. Some tablets which are sold commercially incorporate urea for this purpose. EP-A-711827 (Unilever) teaches the use of sodium citrate for this purpose and EP-A-838519 (Unilever) teaches the use of sodium acetate trihydrate for this purpose.

A number of documents have taught that the disintegration of tablets of cleaning composition can be accelerated by incorporating in the tablet a quantity of a water-insoluble but water-swellable material serving to promote disintegration of the tablet when placed in water at the time of use. Such documents include WO98/40462 (Rettenmaier), WO98/55583 (Unilever) and WO-98/40463 (Henkel).

Typical water-swellable agents which have been disclosed as possible tablet disintegrating agents are starches, cellulose and cellulose derivatives, alginates, dextrans, cross-linked polyvinyl pyrrolidones, gelatines and formaldehyde casein as well as a wide variety of clay minerals and certain ion-exchange resins.

These water-swellable agents often have no function in fabric washing except to aid tablet disintegration. Furthermore, because they are insoluble and of relatively large particle size, they tend to deposit on fabric during the wash. Several attempts have been made to minimise the deposition problem, for example by combining the water-swellable water-insoluble disintegrant with a second, highly soluble disintegration aid (WO98/55582). Other attempts have included use of a preferred particle size of the disintegrant. WO98/55583 (Unilever) claims the use of such material at a particle dimension of at least 400 um to give more efficient disintegration. WO98/55575 and DE 199 01 063 (both Henkel) teach the use of cellulose disintegrating aids with a particle size of less than 100 um to minimise deposition. For DE 199 01 063, the cellulose material is mixed with a material of a given oil absorbing capacity, which includes some zeolites.

We have found that two different measures of tablet strength are relevant to properties observed by a consumer. Force to cause fracture is a direct assessment of strength and indicates the tablets' resistance to breakage when handled by a consumer at the time of use. The amount of energy (or mechanical work) put in prior to fracture is a measure of tablet deformability and is relevant to the tablets' resistance to breakage during transport. Both properties are relevant to consumers' perception of tablets: consumers want tablets to be strong enough to handle, to reach them intact, and to disintegrate quickly and fully at the time of use.

There remains a need to provide a cleaning composition in the form of a tablet, which has adequate strength when dry (so it withstands handling etc) and which disperses/dissolves in an acceptable time when brought into contact with a washing medium such as water. There is a particular need for a tablet that furthermore does not cause unacceptable residues on the substrate being cleaned, and especially, one which also retains good disintegration properties upon storage.

### SUMMARY OF THE INVENTION

Surprisingly, we have now found that a cleaning composition in the form of a tablet which addresses one of more of the aforementioned problems can be obtained if disintegrant granules comprising a co-granulated mixture of a swelling clay, a water insoluble inorganic material and a water-swellable agent are added to the cleaning composition before it is formed into a tablet. This has been found to result in acceptably low levels of residues on the substrate being treated with the tablet and/or with the tablets maintaining good disintegration properties upon storage.

DE 199 15 321 (Henkel) and EP 1 048 719 (Procter & Gamble) disclose disintegrant and softening granules respectively of compacted clay. JP 10110199 (Kao) discloses detergent tablets comprising porous silica and kaolinate clay material as separately added ingredients.

Therefore according to one aspect of the invention a process for the preparation of a disintegrant, suitable for use in a composition in the form of a moulded body, comprises forming by a dry granulation process a granular composition comprising a swelling clay and a water insoluble inorganic material. It should be understood that when we mention a swelling clay in this application we mean a water swelling clay.

According to a preferred embodiment of the invention a process for the preparation of a disintegrant, suitable for use in a composition in the form of a moulded body, comprises forming by a dry granulation process a granular composition comprising a swelling clay, a water insoluble inorganic material and a water-swellable agent which, in its anhydrous state, comprises no more than 20 per cent of the combined weight of said swelling clay, said water insoluble material and said water-swellable agent.

Also according to the present invention there is provided a composition suitable for use as a disintegrant in a composition in the form of a moulded body, said composition being in the form of granules comprising a swelling clay, a water insoluble inorganic material and a water-swellable agent which, in its anhydrous state, comprises no more than 20 per cent of the combined weight of said swelling clay, said water insoluble inorganic material and said water-swellable agent.

We have found that if a water-swellable agent is co-granulated with a swelling clay and a water insoluble inorganic material before being incorporated into a moulded body, particularly in the form of a tablet, then the water-swellable agent is much more efficient in aiding disintegration of the body in use than when it is not co-granulated. Thus, less of the water-swellable agent needs to be added for effective disintegration. When the disintegrant is used in tablets for cleaning materials this effect lowers the probability of deposition of the water-swellable agent on the substrate being cleaned. Moreover, tablets prepared using the granulates according to this invention disintegrate in use readily even after being stored for some time.

The present invention seeks to provide a disintegrant which is useful in a particulate composition in the form of a moulded body and which is relatively inexpensive to manufacture and sufficiently robust to withstand handling during production and packaging processes but readily breaks up and dissolves when contacted with an aqueous medium during the process for which it is intended.

When present, the water-swellable agent preferably comprises, in its anhydrous state, no more than 15 per cent, more preferably no more than 10 per cent, of the combined weight of said swelling clay, said water insoluble inorganic material and said agent in the granular disintegrant. In a typical preferred composition of the invention, the water-swellable agent comprises, in its anhydrous state, no more than 8 per cent, e.g. 7.5 per cent or less, of the combined weight of said swelling clay, said water insoluble inorganic material and said agent. Generally, at least 1 per cent of the combined weight of the water-swellable agent, swelling clay and the water insoluble inorganic material in the granules comprises water-swellable agent.

A feature of the preferred aspect of this invention is the relatively small amount of water-swellable agent that may be employed while securing satisfactory properties for a compacted composition, particularly a cleaning composition. Frequently, the amount of water-swellable agent in a cleaning composition containing the disintegrants of the invention is less than 2 per cent by weight. Preferably, the amount is less than 1 per cent by weight of a cleaning composition but usually at least 0.2 per cent by weight of the water-swellable agent is present in a cleaning composition.

In a preferred process we blend the ingredients of the granules in a mixer followed by roller compaction of the mixture produced, preferably using a pressure of 8-25 mPa. Thereafter the granules are screened to a size of 500 to 3000 μm.

Further the present invention provides a tablet of compacted particulate detergent composition comprising non-soap surfactant and detergency builder, wherein the tablet or a discrete region thereof comprises disintegrant granules comprising a water-swelling clay, a water-insoluble inorganic material and a water swellable agent.

Particularly preferred water insoluble inorganic materials are silica or crystalline aluminosilicates.

An especially preferred embodiment of the present invention is a tablet of compacted particulate detergent composition comprising non-soap surfactant and detergency builder, wherein the tablet or a discrete region thereof comprises disintegrant granules comprising a water-swelling clay, a water insoluble inorganic material and a water-swellable agent which in its anhydrous state, comprises no more than 20% by weight of the combined weight of the water-swelling clay, the water-insoluble inorganic material and the water-swellable agent.

The present invention also provides a process for making a tablet of compacted particulate detergent composition comprising non-soap surfactant and detergency builder, the process comprising mixing disintegrant granules comprising a water-swelling clay, a water-insoluble inorganic material and a water swellable agent with the other constituents of the detergent composition to produce a particulate detergent composition, placing a quantity of the resultant particulate detergent composition within a mould, and, compacting the composition within the mould to produce the tablet.

By the inclusion of a disintegrant granule which is formed by the co-granulation of a water-swelling clay, a water insoluble inorganic material and a water swellable agent in a detergent tablet comprising non-soap surfactant and detergency builder, surprisingly good disintegration after storage of the tablets and/or acceptable residue on a substrate is obtained. It is believed that when the water-swelling clay, water insoluble inorganic material and water swellable agent are used in this co-granulated form it is much more efficient in aiding disintegration of the tablet than when the components are added separately to the composition.

Except in the operating and comparative examples, or where otherwise explicitly indicated, all numbers in this description indicating amounts of material or conditions of reaction, physical properties of materials and/or use are to be understood as modified by the word “about.” All amounts are by weight, unless otherwise specified.

### DETAILED DESCRIPTION

Forms of this invention, including preferred and optional features, and materials which may be used, will now be discussed in greater detail.

A tablet of the present invention may be either homogeneous or heterogeneous. In the present specification, the term “homogeneous” is used to mean a tablet produced by compaction of a single particulate composition, but does not imply that all the particles of that composition will be of identical composition. The term “heterogeneous” is used to mean a tablet consisting of a plurality of discrete regions, for example layers, inserts or coatings, each derived by compaction from a particulate composition. In a heterogeneous tablet according to the present invention, each discrete region of the tablet will preferably have a mass of at least 5 g.

Unless otherwise stated, all references to percentages herein are to percentages by weight based upon the total weight of the tablet, or region thereof.

Disintegrant Granules

A detergent (cleaning) tablet of compacted particulate detergent composition comprising non-soap surfactant and detergency builder material according to the invention comprises a disintegrant in the form of granules, said disintegrant granules comprising a swelling clay, a water insoluble inorganic material and a water swellable agent.

By “water-insoluble” as used herein, in relation to the inorganic material, is meant a compound with a solubility in water at 25° C. of less than 5 grams per 100 grams of water, preferably less than 1 gram per 100 grams of water.

A number of clays are known as swelling clays. The term “swelling” as used herein relates to the ability of the layered clay structure to swell or expand on contact with water, that is, the particle size of a clay particle increases significantly on contact with water. Swelling clays which are particularly suitable for use in this invention include three-layer swelling clays which are materials classified geologically as smectites.

There are two distinct classes of smectite clays. In the first, aluminium oxide is present in the silicate crystal lattice; in the second class, magnesium oxide is present in the silicate crystal lattice. The general formulae of these smectites are Al₂(Si₂O₅)₂(OH)₂ and Mg₃ (Si₂O₅) (OH)₂ for the aluminium and magnesium oxide type clay respectively.

The range of the water of hydration in the clay can vary with the processing to which it has been subjected. Such processing does not significantly affect the swelling characteristics of the hydrated clays as this is dictated by the silicate lattice structure. Furthermore, atom substitution by iron and magnesium can occur within the crystal lattice of the smectites, while metal cations such as Na⁺, Ca²⁺, as well as H⁺, can be co-present in the water of hydration to provide electrical neutrality.

The three-layer, swelling alumino silicates clays useful in the invention are further characterised by a dioctahedral crystal lattice, while the swelling three-layer magnesium silicates have a trioctahedral crystal lattice.

The clays employed in the invention can contain cationic counterions such as protons, sodium ions, potassium ions, calcium ions and magnesium ions. It is customary to distinguish between clays on the basis of one cation predominantly or exclusively absorbed. For example, a sodium clay is one in which the absorbed cation is predominantly sodium. Such absorbed cations can become involved in exchange reactions with cations present in aqueous solutions.

Particularly suitable smectite clays include montmorillonite and hectorite clays. One class of naturally-occurring montmorillonite clays is known as the bentonite clays and these have been found to be especially useful in the present invention. Different forms of bentonite clays are known in which the inherent negative charge of the clay matrix is balanced by different cations. The naturally-occurring forms where the cation is predominantly either sodium (sodium clay) or calcium (calcium clay) are suitable, as is the material produced by treating calcium bentonite with a compound of sodium and with other cations.

The smectite clays used in the present invention are commercially available. Such clays include in addition to those mentioned hereinabove, saponite, volchonskoite, nontronite and sauconite. Suitable clays are available under various trade names such as GELWHITE™ GP, Bentonite L, H and MB all from Southern Clay, USA; clays available under the tradename VOLCAY™ from American Colloid Co., USA. Other suitable clays are available commercially. The smectite minerals obtained under these commercial and trade names can comprise mixtures of the various discrete mineral entities. Such mixtures of the smectite minerals are suitable for use in the invention.

A preferred bentonite clay is a calcium-form bentonite clay which has been treated with a sodium compound. For example a calcium-form bentonite clay which has been treated with sodium carbonate and which is sold under the trade names BREBENT™ and FLUGEL™ (ex Laporte PLC). The weight mean particle size of these clays is between 5 and 25 microns when measured by Malvern Mastersizer using the method described hereinbelow. These clays contain relatively high levels of sodium for what is termed a “calcium-form” clay. Calcium form clays have been found to be especially suitable according to the present invention.

Smaller particle sizes have been found to give fewer problems with residues on the substrate.

The weight mean particle size of the materials used in this invention is determined using a Malvern Mastersizer model X, with a lens range of up to 300 mm RF and MS17 sample presentation unit. This instrument, made by Malvern Instruments, Malvern, England, uses the principle of Mie scattering, using a low power HE/NE laser. Before measurement the sample is initially dispersed ultrasonically in water for seven minutes to form an aqueous suspension. This suspension is stirred before it is subjected to the measurement procedure outlined in the instruction manual for the instrument utilising the 300 mm RF lens in the detector system. The Malvern Mastersizer measures the weight particle size distribution of the inorganic or reference material. The weight mean particle size (d₅₀) or 50 percentile is readily obtained from the data generated by the instrument.

Smectite clays of a neutral or white colour are preferred for forming the disintegrant granule, especially for neutrally coloured detergent tablets.

Clays having a Na₂O content of less than about 4% by weight and a CaO content of less than about 1.5% by weight have been found to be effective according to the present invention.

Suitable water-insoluble inorganic materials include silica, aluminosilicates, aluminas, calcium carbonate, barium sulphate, titanium dioxide and other pigments. Preferred water insoluble materials are silica, materials consisting of at least 70% silica by weight, and, aluminosilicates.

The aluminosilicate is preferably a crystalline aluminosilicate, usually a zeolite, particularly a zeolite suitable for use in a detergent formulation. Useful zeolites include zeolite P, A, X and Y and mixtures thereof, with zeolite P and zeolite A being preferred. Zeolite P is especially preferred. A type of Zeolite P known as maximum aluminium zeolite P (e.g. DOUCIL A24 ex Ineos Silicas, UK), has been found to be especially effective and is referred to herein as zeolite MAP.

In general the empirical formula of a zeolite is;

M_{2/n}O.Al₂O₃.xSiO_{2.y}H₂O

wherein M represents a metallic cation having a valency of n, x indicates the ratio of atoms of silica to atoms of aluminium and y indicates the ratio of molecules of water to atoms of aluminium. Many different types of zeolite, with varying ratios of silica to alumina are known. Commonly, M is an alkali metal.

Zeolites of use in this invention may have the structure of any known zeolites. The structure and characteristics of many zeolites are described in the standard work “zeolite Molecular Sieves” by Donald W Brock, published by Robert E Krieger Publishing Company. Usually the value of x in the above empirical formula is in the range 1.5 to 10. The value of y, which represents the amount of water contained in the voids of the zeolite can vary widely. In anhydrous material y=0 and, in fully hydrated material y may be up to 5.

Zeolites useful in this invention may be based on naturally-occurring or synthetic aluminosilicates and the preferred forms of zeolite have the structure known as zeolite P, zeolite X or Zeolite A. Particularly preferred forms of zeolite are those disclosed in EP-A-0 384 070, EP-A-565 364, EP-A-0 697 010, EP-A-0 742 780, WO 96/34828 and WO 97/06102, the entire contents of which are incorporated herein by reference. The zeolite P described in EP-A-0 384 070 has the empirical formula given above in which M represents an alkali metal cation and x has a value up to 2.66, preferably in the range 1.8 to 2.66, and has a structure that is particularly useful according to the invention and is known as maximum aluminium zeolite P as described above.

It has been found that the granular disintegrants of the invention are more effective when the zeolites used to prepare them contain relatively little water. The preferred amount of water in the zeolite depends upon the type of zeolite used. For zeolites A and P, it is preferred that the amount of water is less than 21% by weight of the zeolite, more preferably less than 15% by weight, especially 8 to 13% by weight, such as 9 to 12% by weight. A particularly useful form of zeolite P which contains from about 9 to about 12% by weight of water is zeolite MAP. As the water content in zeolite P is increased above this range, the effectiveness as a disintegrant decreases with increasing water content. Fully hydrated zeolite P has been found to be less effective as a disintegrant when compared to zeolite MAP.

It is preferred according to the invention, that the zeolite used as the inorganic carrier shows a volume increase upon contact with water at 20° C.

The relative amount of the water-swelling clay and the water-insoluble inorganic material, particularly the crystalline aluminosilicate, in the granular disintegrant is preferably in the weight ratio range of from 9:1 to 1:9, more preferably 6:1 to 1:5, such as 2:1 to 1:4 by weight of the clay: inorganic material. Good results have been obtained with ratios in the range from 1.5:1 to 1:3 by weight water-swelling clay: inorganic material.

The water-swelling clay is preferably present in the disintegrant granule in an amount of from 10 to 50% by weight, preferably 20 to 50 and more preferably 20 to 45% by weight, such as 30 to 40% by weight based on the weight of the disintegrant granule. The water-insoluble inorganic material is preferably present in an amount of from 35 to 80% by weight preferably 35 to 70%, more preferably 45 to 70% by weight, such as 50 to 60% by weight based on the weight of the disintegrant granule. The water-swellable agent is preferably present in an amount of from 1 to 10% by weight, preferably 3 to 9% by weight, such as 5 to 9% by weight based on the weight of the disintegrant granule.

Alkali metal aluminosilicates, especially zeolites, are commonly used in detergent compositions as builders as further described hereinbelow. Where a composition according to the invention comprises an alkali metal aluminosilicate as a detergency builder, it is preferred that at least a part of the builder content of the cleaning composition is employed as the aluminosilicate material in the disintegrant granules. As stated below, the builder, e.g. aluminosilicate constituent, typically comprises 10 to 60% by weight of the total composition. Preferably, when zeolite is used in the disintegrant granules and as a detergency builder in the composition, then at least 1% by weight of the total weight of the composition comprises a zeolite constituent employed in the form of disintegrant granules.

Preferably, the water insoluble inorganic materials have a primary average particle size below 10 μm and, more preferably, the average particle size is below 5 μm, as measured using a Malvern Mastersizer (Trade Mark)

It is especially preferred that the disintegrant granules comprise a water-swellable agent which in its anhydrous state, comprises no more than 15% by weight, more preferably no more than 10% by weight, most preferably no more than 8% wt, such as 7.5% or less of the combined weight of said swelling clay, said water insoluble inorganic material and said water-swellable agent in the granular disintegrant. Generally, at least 1% of the combined weight of said swelling clay, said inorganic material and said water-swellable agent in the granular disintegrant comprises water-swellable agent. Preferably the water-swellable agent comprises 1 to 8% by weight of the combined weight of the water-swelling clay, water-insoluble inorganic material and water-swellable agent.

A relatively small amount of the water-swellable agent may, surprisingly, be used in the tabletted composition of the invention whilst still providing acceptable properties in the tabletted composition. Usually the amount of water-swellable agent in the tabletted composition, based on the total weight of the tabletted composition, is less than 2% by weight, preferably less than 1% of the composition. Usually however, at least 0.2% by weight of the water-swellable agent, based on the total weight of the tabletted composition, is present.

Typically the water-swellable agent comprises a polymer, often a wholly or partially cross-linked polymer, e.g. natural cellulose, cross-linked cellulose, (sodium) carboxy methyl cellulose, cross-linked sodium carboxymethyl cellulose, pre-gelatinised starch, cross-linked starch or cross-linked polyvinyl pyrrolidone. Currently preferred are Aquasorb A500 (ex Hercules) and Ac-Di-Sol™ and Nilyn™ XL 90 (ex FMC Corporation, USA).

The water swellable agent in the disintegrant granule is preferably a cross-linked carboxymethyl cellulose, such as Aquasorb™ A500 and Ac-Di-Sol™ and Nilyn XL 90 as mentioned above. Cross-linked sodium carboxymethyl cellulose is especially preferred. It is believed that these cross-linked carboxymethyl celluloses have particularly suitable levels of cross-linking and/or degree of substitution for use in the present invention.

Generally the compositions of the invention will contain from 1 to 20% by weight of the disintegrant granules based on the total weight of the compositions, preferably 1 or 2% to 15%, such as 3 to 10%, e.g. 4 to 8% by weight of the disintegrant granules. If the granules are included to aid dissolution of the tablets rather than disintegration, then the amount of the granules in the tablets could be as low as 1% by weight.

The water-swellable agent preferably has an average primary particle size up to about 600 um, but, conveniently, has an average primary particle size of no more than 200 um, preferably no more than 100 um.

The water swellable agent preferably has a water-swelling capacity of at least 5 cm³/gram, preferably 10 cm³/gram and more preferably 20 cm³/gram as determined in the test described hereinbelow.

The disintegrant granules preferably have a mean particle size in the range 250 to 1500 micrometers, more preferably 500 to 1200 microns, most preferably 700 to 1200 microns.

The granules of swelling clay, water insoluble inorganic material and water-swellable agent are in a preferred embodiment prepared by a dry granulation process. A typical known process for producing granules of inorganic material comprises mixing the inorganic material with water or an aqueous liquid, agitating the wet mixture until granules are formed and subsequently removing water from the granules. In the dry granulation process of the current invention the granules are produced without the use of water or an aqueous liquid. The dry granulation process can be any of the processes that will be known to those skilled in the art, e.g. by blending the dry ingredients in a mixer (such as a Pek mixer available from George Tweedy & Co of Preston—281b S.A. Machine) and compacting on a roller compactor (Alexanderwerk WP50—manufactured by Alexanderwerk AG, D 5630 Remschied 1, Germany) and a Lodige mixer available from Gebr. Lodige Maschinebau, Paderborn, Germany, as well as low/medium shear mixers such as the orbiting screw Nautamixer available from Vrleco-Nauta, Holland or a ribbon mixer as supplied, for example, by Morton, Motherwell, Scotland. Suitable roller compactors include the Alexanderwerk WP50 manufactured by Alexanderwerk AG, Remscheid, Germany, the IR520 Chilsonator available from Fitzpatrick Company, Ill., USA and a roller compactor from Hosokawa Bepex of Minneapolis, USA.

A typical small-scale preparative method is now described in detail. Swelling clay, inorganic material, and particles of the water-swellable agent are blended together in appropriate portions in a Pek mixer for 30 minutes. A minimum of 2 kg of blended material so prepared is compacted by feeding into an Alexanderwerk roller compactor, fitted with a sintered block vacuum de-aeration system. The roller pressure is selected according to the strength of granule desired, higher pressures leading to stronger granules. Generally, roller pressure is between 8 and 25 Mpa and a typical roller pressure is 10 Mpa. The compacted material from the compactor is fed into a granulator, which forms part of the machine, and forced through a mesh and the resulting granules are then screened to the desired particle size range, e.g. a mean average particle size of 250 to 3000 μm, using standard laboratory sieves. Preferably the particles have a particle size of 700 to 1500 um. The granules, however produced, comprise an intimate mixture of particles of swelling clay, inorganic material and water-swellable agent.

An especially effective disintegrant granule has been found to be one comprising a mixture, preferably co-granulated, of a bentonite clay produced by treating calcium-form bentonite with a compound of sodium, zeolite MAP and a cross-linked sodium carboxy methyl cellulose.

Surfactant Compounds

The compositions of this invention contain one or more non-soap surfactants. In a fabric washing composition, these preferably provide from 5 to 50% by weight of the composition of the tablet or region thereof, more preferably from 8 or 9% by weight of the composition up to 35% or 40% by weight. If the tablet is composed of more than one discrete region, then these preferred amounts of surfactant may apply to the tablet as a whole.

The organic surfactant may be present as a component in granulated particles in an amount between 10 and 70% by weight of the particles, more preferably 15 to 50% by weight based on the total weight of the granulated particles. All the surfactant in the composition may be contained within these particles. Surfactant may be anionic, cationic, zwitterionic, amphoteric, nonionic or a combination of these.

In a fabric washing tablet, anionic surfactant may be present in an amount from 0.5 to 50% by weight, preferably from 2% or 4% up to 30% or 35% or 40% by weight of the tablet or region thereof.

In a machine dishwashing composition, organic surfactant is likely to constitute from 0.5 to 8%, more likely from 0.5 to 5% of the composition of the tablet or region thereof and is likely to consist of nonionic surfactant, either alone or in a mixture with anionic surfactant. Synthetic (i.e. non-soap) anionic surfactants are well known to those skilled in the art. Examples include alkyl benzene sulphonates, particularly sodium linear alkyl benzene sulphonates having an alkyl chain length of C₈-C₁₅; olefin sulphonates; alkane sulphonates; dialkyl sulphosuccinates; and fatty acid ester sulphonates.

Primary alkyl sulphate having the formula:

ROSO₃⁻M⁺

in which R is an alkyl or alkenyl chain of 8 to 18 carbon atoms especially 10 to 14 carbon atoms and M⁺ is a solubilising cation, is commercially significant as an anionic surfactant.

Linear alkyl benzene sulphonate of the formula;

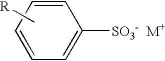

where R is linear alkyl of 8 to 15 carbon atoms and M⁺ is a solubilising cation, especially sodium, is also a commercially significant anionic surfactant.

Frequently, such linear alkyl benzene sulphonate or primary alkyl sulphate of the formula above, or a mixture thereof will be the desired anionic surfactant and may provide 75 to 100 wt % of any anionic non-soap surfactant in the composition. In some forms of this invention the amount of non-soap anionic surfactant lies in a range from 5 to 20 or 25 wt % of the tablet or region thereof.

It may also be desirable to include one or more soaps of fatty acids. These are preferably sodium soaps derived from naturally occurring fatty acids, for example, the fatty acids from coconut oil, beef tallow, sunflower or hardened rape seed oil.

Suitable nonionic surfactant compounds which may be used include in particular the reaction products of compounds having a hydrophobic group and a reactive hydrogen atom, for example, aliphatic alcohols, acids, amides or alkyl phenols with alkylene oxides, especially ethylene oxide.

Specific nonionic surfactant compounds are alkyl (C₈₋₂₂) phenol-ethylene oxide condensates, the condensation products of linear or branched aliphatic C₈₋₂₀ primary or secondary alcohols with ethylene oxide, and products made by condensation of ethylene oxide with the reaction products of propylene oxide and ethylene-diamine.

Especially preferred are the primary and secondary alcohol ethoxylates, especially the C₉₋₁₁ and C₁₂₋₁₅ primary and secondary alcohols ethoxylated with an average of from 5 to 20 moles of ethylene oxide per mole of alcohol.

In certain forms of this invention the amount of nonionic surfactant lies in a range from 4 to 40% by weight, better 4 or 5 to 30% by weight of the composition of the tablet or region thereof. Many nonionic surfactants are liquids. These may be absorbed onto particles of the composition prior to compaction into tablets.

Amphoteric surfactants which may be used jointly with anionic or nonionic surfactants, or both, include amphopropionates of the formula;

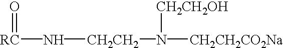

where RCO is an acyl group of 8 to 18 carbon atoms, especially coconut acyl.

The category of amphoteric surfactants also includes amine oxides and also zwitterionic surfactants, notably betaines of the general formula;

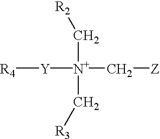

where R₄ is an aliphatic hydrocarbon chain which contains 7 to 17 carbon atoms, R₂ and R₃ are independently hydrogen, alkyl of 1 to 4 carbon atoms or hydroxyalkyl of 1 to 4 carbon atoms such as CH₂OH, Y is CH₂ or of the form CONHCH₂CH₂CH₂ (amidopropyl betaine); Z is either a COO⁻ (carboxybetaine), or of the form CHOHCH₂SO₃—(sulfobetaine or hydroxy sultaine).

Another example of amphoteric surfactant is amine oxide of the formula;

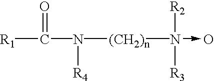

where R₁ is C₁₀ to C₂₀ alkyl or alkenyl; R₂, R₃ and R₄ are each hydrogen or C₁ to C₄ alkyl, while n is from 1 to 5.

Cationic surfactants may possibly be used. These frequently have a quaternised nitrogen atom in a polar head group and an attached hydrocarbon group of sufficient length to be hydrophobic. A general formula for one category of cationic surfactants is;

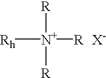

where each R independently denotes an alkyl group or hydroxyalkyl group of 1 to 3 carbon atoms and Rₕ denotes an aromatic, aliphatic or mixed aromatic and aliphatic group of 6 to 24 carbon atoms, preferably an alkyl or alkenyl group of 8 to 22 carbon atoms and X⁻ is a counterion.

The amount of amphoteric surfactant, if any, may be from 3% to 20 or 30% by weight of the tablet or region of a tablet; the amount of cationic surfactant, if any, may be from 1% to 10 or 20% by weight of the tablet or region of a tablet.

Detergency Builder

A composition which is compacted to form tablets or tablet regions typically contains a detergency builder which serves to remove or sequester calcium and/or magnesium ions in the water. Thus the builder acts as a water softener. In detergent tablets the amount of builder is likely to be from 5% to 80%, more usually 10% or 15% to 40%, 55% or 60% by weight of the tablet.

The detergency builder may be present in granulated particles in an amount of from 20 to 80% by weight, more preferably 20%, 25% or 30 to 60% by weight.

Detergency builders may be provided wholly by water soluble materials, or may be provided in large part or even entirely by water-insoluble material with water-softening properties.

Alkali metal aluminosilicates are strongly favoured as environmentally acceptable detergency builders for fabric washing, and are preferred in this invention. Alkali metal (preferably sodium) aluminosilicates may be either crystalline or amorphous or mixtures thereof, having the general formula:

0.8-1.5 Na₂O.Al₂O₃.0.8-6 SiO_{2.} xH₂O

These materials contain some bound water (indicated as xH₂O) and are required to have a calcium ion exchange capacity of at least 50 mg CaO/g. The preferred sodium aluminosilicates contain 1.5-3.5 SiO₂ units (in the formula above). Both the amorphous and the crystalline materials can be prepared readily by reaction between sodium silicate and sodium aluminate, as amply described in the literature.

Suitable crystalline sodium aluminosilicate ion-exchange materials are described, for example, in GB 1 429 143 (Procter & Gamble). The preferred sodium aluminosilicates of this type are the well known commercially available zeolites A and X, the newer zeolite P described and claimed in EP 384 070 (Unilever) and mixtures thereof. This form of zeolite P is also referred to as “zeolite MAP” as referred to hereinabove.

Conceivably a detergency builder could be a layered sodium silicate as described in U.S. Pat. No. 4,664,839. NaSKS-6 is the trademark for a crystalline layered silicate marketed by Hoechst (commonly abbreviated as “SKS-6”). NaSKS-6 has the delta-Na₂SiO₅ morphology form of layered silicate. It can be prepared by methods such as described in DE-A-3,417,649 and DE-A-3,742,043. Other such layered silicates, such as those having the general formula NaMSiₓO₂ₓ₊₁.yH₂O wherein M is sodium or hydrogen, x is a number from 1.9 to 4, preferably 2, and y is a number from 0 to 20, preferably 0 can be used.

The less preferred category of water-soluble phosphorus-containing inorganic softeners includes the alkali-metal orthophosphates, metaphosphates, pyrophosphates and polyphosphates. Specific examples of inorganic phosphate detergency builders include sodium and potassium tripolyphosphates, orthophosphates and hexametaphosphates.

Non-phosphorus water-soluble detergency builders may be organic or inorganic. Inorganics that may be present include alkali metal (generally sodium) carbonate; while organics include polycarboxylate polymers, such as polyacrylates, acrylic/maleic copolymers, and acrylic phosphonates, monomeric polycarboxylates such as citrates, gluconates, oxydisuccinates, glycerol mono- di- and trisuccinates, carboxymethyloxysuccinates, carboxymethyloxymalonates, dipicolinates and hydroxyethyliminodiacetates.

Tablet compositions preferably include polycarboxylate polymers, more especially polyacrylates and acrylic/maleic copolymers which have some function as water-softening agents and also inhibit unwanted deposition onto fabric from the wash liquor.

Where the tablet contains water soluble builder it is preferably present in an amount of from 10 to 80% by weight based on the total weight of the tablet or region thereof. Where the tablet contains water in-soluble builder it is preferably present in an amount of from 5 to 80% by weight based on the total weight of the tablet or region thereof.

Tablets comprising from 4 to 50% by weight of surfactant and from 5 to 80% by weight of builder are especially preferred for fabric washing tablets. Tablets comprising from 1 to 5% by weight of surfactant and from 50 to 98% of detergency builder are especially preferred for machine dishwashing tablets.

For the avoidance of doubt, where a tablet is heterogenous, the percentage ranges for the components referred to herein may apply to the overall composition of the tablet, as well as to at least one region of the tablet.

Water-Soluble Disintegration-Promoting Particles

The compositions of the invention, in either the whole tablet or in a region thereof, may contain water-soluble disintegration promoting particles in addition to the disintegrant granules. It is preferred that such disintegration-promoting particles make up from 2%, 3%, 5%, 8% or 10% up to 15%, 20%, 25% or 30% by weight of the composition of the tablet or region thereof. It is especially preferred that such disintegration-promoting particles make up from 5% to 25% by weight of the composition, based on the total weight of the composition.

Such soluble particles typically contain at least 40% (of their own weight) of one or more materials which is other than soap or organic surfactant and which has a solubility in deionised water of at least 30g/100 g at 20° C.

Preferably, at least a part of the water-soluble disintegration-promoting particles is added to a pre-granulated portion of the composition used to produce the tablet. A small proportion of such soluble material may also be included in granulated particles which may contain organic surfactant and/or detergency builder, in an amount of preferably 1 to 25% by weight, more preferably 3 or 5% to 10% or 15% by weight of these granulated particles.

More preferably this water-soluble material is selected from compounds containing at least 40% (by weight of the particles) of one or more materials selected from the group consisting of; compounds with a water-solubility exceeding 50 grams/100 grams in water at 20° C.; or sodium tripolyphosphate containing at least 50% of its own weight of the phase I anhydrous form; or sodium tripolyphosphate which is partially hydrated so as to contain water of hydration in an amount which is at least 0.5% by weight of the sodium tripolyphosphate in the particles.

As will be explained further below, these disintegration-promoting particles can also contain other forms of tripolyphosphate or other salts within the balance of their composition.

If the material in such water-soluble disintegration-promoting particles can function as a detergency builder, (as is the case with sodium tripolyphosphate) then of course it contributes to the total quantity of detergency builder in the tablet composition.

A solubility of at least 50 g/100 g of deionised water at 20° C. is an exceptionally high solubility: many materials which are classified as water soluble are less soluble than this.

Some highly water-soluble materials which may be used are listed below, with their solubilities expressed as grams of solid to form a saturated solution in 100 grams of deionised water at 20° C.

| | Water Solubility (grams/100 |
|---|---|
| Material | grams water) |
| Sodium citrate dihydrate | 72 |
| Potassium carbonate | 112 |
| Urea | >100 |
| Sodium acetate | 119 |
| Sodium acetate trihydrate | 76 |
| Magnesium sulphate 7H₂0 | 71 |

By contrast the solubilities of some other common materials at 20° C. are:-

| Material | Water Solubility (g/100 g) |
|---|---|
| Sodium chloride | 36 |
| Sodium sulphate decahydrate | 21.5 |
| Sodium carbonate anhydrous | 8.0 |
| Sodium percarbonate anhydrous | 12 |
| Sodium perborate anhydrous | 3.7 |
| Sodium tripolyphosphate anhydrous | 15 |

Preferably this highly water soluble material is incorporated as particles of the material in a substantially pure form (i.e. each such particle contains over 95% by weight of the material). However, the said particles may contain material of such solubility in a mixture with other material, provided that material of the specified solubility provides at least 50% by weight of these particles.

Preferred water-soluble materials having a solubility exceeding 50 grams/100 grams of deionised water at 20° C. are sodium citrate dihydrate, urea, and sodium acetate which may be in a partially or fully hydrated form (trihydrate). Sodium acetate trihydrate is especially preferred.

It may be preferred that the highly water-soluble material is a salt which dissolves in water in an ionised form. As such a salt dissolves it leads to a transient local increase in ionic strength which can assist disintegration of the tablet by preventing nonionic surfactant from swelling and inhibiting dissolution of other materials.

Specifically, tablets of this invention may contain water-soluble salt, with a solubility exceeding 50g/100 g of deionised water at 20° C., both as a small percentage within the said granulated particles and as separate particles which are mixed with them.

Within granulated particles which may contain surfactant and/or builder, such highly water soluble salt may be present in an amount from 0 to 30% by weight of those particles, preferably from 3 to 10% or 15% thereof, while the materials added to those particles before tabletting may be such highly soluble salts in an amount from 2 or 5% up to 15% of the whole tablet formulation.

Another possibility which is less preferred is that the said particles which promote disintegration are particles which contain sodium tripolyphosphate with more than 50% (by weight of the particles) of the anhydrous phase I form, and, which is partially hydrated so as to contain water of hydration in an amount which is at least 1% by weight of the sodium tripolyphosphate.

Sodium tripolyphosphate is very well known as a sequestering builder in detergent compositions. It exists in a hydrated form and two crystalline anhydrous forms. These are the normal crystalline anhydrous form, known as phase II which is the low temperature form, and phase I which is stable at high temperature. The conversion of phase II to phase I proceeds fairly rapidly on heating above the transition temperature, which is about 420° C. but the reverse reaction is slow. Consequently phase I sodium tripolyphosphate is metastable at ambient temperature.

A process for the manufacture of particles containing a high proportion of the phase I form of sodium tripolyphosphate by spray drying below 420° C. is given in U.S. Pat. No. 4,536,377. These particles should also contain sodium tripolyphosphate which is partially hydrated. The extent of hydration should be at least 1% by weight of the sodium tripolyphosphate in the particles. It may lie in a range from 1 to 4%, or it may be higher. Indeed fully hydrated sodium tripolyphosphate may be used to provide these particles.

The remainder of the tablet composition used to form the tablet or region thereof may include additional sodium tripolyphosphate. This may be in any form, including sodium tripolyphosphate with a high content of the anhydrous phase II form. Suitable material is commercially available. Suppliers include Rhone-Poulenc, France and Rhodia, UK.

Some countries require that phosphate is not used. For such countries, a zero-phosphate tablet in accordance with this invention may utilise a suitable amount, e.g. 15% by weight or more of disintegration-promoting material with solubility of at least 50gm/100 gm at 20° C. Other countries permit the use, or at least some limited use, of phosphates, making it possible to use some sodium tripolyphosphate.

Optional Water-Soluble Organic Polymer

Tablets of the present invention may include a water-soluble organic polymer which is solid at 25° C. to act as a binder for the particulate composition when compacted. This may be included in granulated particles containing organic surfactant and/or detergency builder.

The term “solid” is used here to denote materials which have the appearance of an immobile solid at 25° C. and can be handled as solids. They contrast with liquids which, even if viscous, can be seen to be capable of fluid flow. Organic polymers are general amorphous materials which are strictly classified as supercooled liquids—but of such high viscosity that for practical purposes they are solid.

The terms water-soluble is used here in relation to this organic polymer to indicate that when the polymer is placed in water it appears, on visual inspection, to dissolve.

Whether the solution is a true isotropic solution or has some colloidal character is not important to this invention.

It is preferred that the polymer material should melt at a temperature of at least 35° C., better 40° C. or above, which is above ambient temperatures in many temperate countries. For use in hotter countries it will be preferable that the melting temperature is somewhat above 40° C₁ so as to be above the ambient temperature.

Some polymers which may be used are solids at temperatures up to 100° C., that is to say they retain a solid appearance even though they are in an amorphous state. They may soften and melt to a mobile liquid on heating further, or may decompose without melting on heating sufficiently in excess of 100° C. Such polymers will generally be added as a powder during the course of granulation. Another possibility would be addition as a solution in a volatile organic solvent, but that is not preferred.

Other polymers which may be used melt to liquid form at temperatures not exceeding 80° C. and may be sprayed as molten liquid onto the surfactant and builder mixture during the course of granulation.

Organic polymers are in general amorphous solids. A significant parameter characterising amorphous solids is their glass transition temperature. When an amorphous hydrophilic polymer absorbs moisture, the moisture acts as a plasticiser and lowers the glass transition temperature of the polymer. Suitable polymers may have a glass transition temperature, when anhydrous, which is from 300 to 500K (i.e. approximately 25° C. to 225° C.) but may be incorporated in a moisture-containing state so that their glass transition temperature is lower.

A preferred polymer is polyethylene glycol. Preferred polymer materials are synthetic organic polymers especially polyethylene glycol. Polyethylene glycol of average molecular weight 1500 (PEG 1500) melts at 45° C. and has proved suitable. Polyethylene glycol of higher molecular weight can also be used (PEG 4000 melts at 56° C. and PEG 6000 at 58° C.). Other possibilities are polyvinylpyrrolidone, and polyacrylate and water-soluble acrylate copolymers.

The amount of water-soluble polymer included in particles which may also contain organic surfactant and detergency builder is preferably between 0.2% or 0.5% or 1% and 15% by weight of the particles, possibly at least 1.5 or 3%. Further preferred is that the amount is not over 7 or 10% by weight. Alternatively, the amount of water-soluble polymer present may be defined in terms of the whole composition of the tablet or region thereof, in which case, it is desirably present in an amount of between 0.5% and 5% by weight, more preferably 0.5 to 4% by weight. In some cases the addition of the polymer has been found to hinder slightly, the disintegration of the tablet. Thus for some formulations the level of the water-soluble polymer is preferably in the range 0.5 to 2% by weight.

Optional Bleach System

Tabletted compositions according to the invention may contain a bleach system. This preferably comprises one or more peroxy bleach compounds, for example, inorganic persalts or organic peroxyacids, which may be employed in conjunction with activators to improve bleaching action at low wash temperatures. If any peroxygen compound is present, the amount is likely to lie in a range from 10 to 25% by weight of the composition of the tablet or region thereof.

Preferred inorganic persalts are sodium perborate monohydrate and tetrahydrate, and sodium percarbonate, advantageously employed together with an activator. Bleach activators, also referred to as bleach precursors, have been widely disclosed in the art. Preferred examples include peracetic acid precursors, for example, tetraacetylethylene diamine (TAED), now in widespread commercial use in conjunction with sodium perborate and percarbonate; and perbenzoic acid precursors. The quaternary ammonium and phosphonium bleach activators disclosed in U.S. Pat. No. 4,751,015 and U.S. Pat. No. 4,818,426 (Lever Brothers Company) are also of interest. Another type of bleach activator which may be used, but which is not a bleach precursor, is a transition metal catalyst as disclosed in EP-A-458 397, EP-A-458 398 and EP-A-549 272. A bleach system may also include a bleach stabiliser (heavy metal sequestrant) such as ethylenediamine tetramethylene phosphonate and diethylenetriamine pentamethylene phosphonate.

Enzymes

Tablets according to the invention may comprise one or more detergency enzymes. Preferably the enzyme is selected from amylase, protease, cellulase, lipase and mixtures thereof. The aforementioned enzymes are designed to remove a variety of soils and stains from fabrics.

Detergency enzymes well known in the art for their ability to degrade and aid in the removal of various soils and stains. Examples of suitable proteases are Maxatase (Trade Mark), as supplied by Gist-Brocades N.V., Delft, Holland, and Alcalase (Trade Mark), and Savinase (Trade Mark), as supplied by Novo Industri A/S, Copenhagen, Denmark. Detergency enzymes are commonly employed in the form of granules or marumes, optionally with a protective coating, in amount of from about 0.1% to about 3.0% by weight of the composition of the tablet or region thereof; and these granules or marumes present no problems with respect to compaction to form a tablet.

Optional Other Ingredients

The tablets of the invention may also contain a fluorescer (optical brightener), for example, Tinopal (Trade Mark) DMS or Tinopal CBS available from Ciba-Geigy AG, Basel, Switzerland. Tinopal DMS is disodium 4,4′bis-(2-morpholino-4-anilino-s-triazin-6-ylamino) stilbene disulphonate; and Tinopal CBS is disodium 2,2′-bis-(phenyl-styryl) disulphonate.

An antifoam material is advantageously included if organic surfactant is present, especially if a detergent tablet is primarily intended for use in front-loading drum-type automatic washing machines. Suitable antifoam materials are usually in granular form, such as those described in EP 266 863A (Unilever). Such antifoam granules typically comprise a mixture of silicone oil, petroleum jelly, hydrophobic silica and alkyl phosphate as antifoam active material, sorbed onto a porous absorbed water-soluble carbonate-based inorganic carrier material. Antifoam granules may be present in an amount up to 5% by weight of the composition of the tablet or region thereof.

It may also be desirable that a tablet of the invention includes an amount of an alkali metal silicate, particularly sodium ortho-, meta- or disilicate. The presence of such alkali metal silicates at levels, for example, of 0.1 to 10 wt %, may be advantageous in providing protection against the corrosion of metal parts in washing machines, besides providing some measure of building and giving processing benefits in manufacture of the particulate material which is compacted into tablets. A composition for fabric washing will generally not contain more than 15wt % silicate. A tablet for machine dishwashing will frequently contain at least 20 wt % silicate.

Procedures and Tests (Part 1)

Bulk Density of Non-Compacted Detergent Powder & Granulation Process

While the starting particulate composition from which the tablets are produced may in principle have any bulk density, the present invention may be especially relevant to tablets of detergent composition made by compacting powders of relatively high bulk density, because of their greater tendency to exhibit disintegration and dispersion problems.

Such tablets have the advantage that, as compared with a tablet derived from a low bulk density powder, a given dose of composition can be presented as a smaller tablet.

Thus the starting particulate composition may suitably have a bulk density of at least 400 g/litre, preferably at least 500 g/litre, and possibly at least 600 g/litre.

Granular detergent compositions of high bulk density prepared by granulation and densification in a high-speed mixer/granulator, as described and claimed in EP-A-340 013 (Unilever), EP-A-352 135 (Unilever), and EP-A-425 277 (Unilever), or by the continuous granulation/densification processes described and claimed in EP-A-367 339 (Unilever) and EP-A-390 251 (Unilever), are inherently suitable for use in the present invention.

Another particularly suitable process for the preparation of a high-bulk density detergent powder is described in WO-A-98/11193 (Unilever). In this document, a feedstock of the starting acid for production of the anionic surfactant is partially neutralised, for example by sodium hydroxide, before being fed into a high-speed mixer densifier (e.g. Lodige CB 30 Recycler) where the partially neutralised acid feedstock is completely neutralised, whilst being mixed with the majority of other components of the detergent base powder granule. This powder can be further densified by treating in a moderate speed mixer (e.g. Lodige KM 300 mixer), before which stage further detergency builder may be added. The water-soluble polymer material is preferably added before the further densification step, although it may be added in the first mixer. The water-soluble polymer material may be heated to a temperature considerably above its melting point to obtain a free-flowing liquid. The resulting powder can be cooled and dried using a fluid bed, after which any desired particle size control can be exercised.

Any separate particles containing further components of the finished formulation can be mixed with the base powder prior to compaction.

Particle Size Control

Particle sizes can be controlled in the manufacturing process of any particles included in the composition. Oversize particles are usually removed by sieving (for example by a Mogensen screen) at the end of the production process, followed by milling and recycling of the removed oversize fraction. Undersize particles can also be removed by sieving, or if the manufacturing process employs a fluidised bed undersized particles may be entrained in the air stream and subsequently recovered from it for recycling to the granulation stage.

It is preferred that the average particle size of granulated particles forming the particulate composition from which the tablet is formed is between 400 and 1100 micrometers, preferably between 500 and 1000 micrometers. Preferably no more than 5% of these particles is smaller than 200 micrometers while no more than 5% is larger than 1400 micrometers.

Materials which are mixed with the granulated particles may also comply with these requirements concerning particle size. These materials (post-added) typically comprise from 5%-60% by weight of the total weight of the final composition, more usually 35 to 55% by weight.

Tabletting

Tabletting entails compaction of a particulate composition. A variety of tabletting machinery is known, and can be used. Generally it will function by stamping a quantity of the particulate composition which is confined in a die. Tabletting may be carried out at ambient temperature or at a temperature above ambient which may allow adequate strength to be achieved with less applied pressure during compaction. In order to carry out the tabletting at a temperature which is above ambient, the particulate composition is preferably supplied to the tabletting machinery at an elevated temperature. This will of course supply heat to the tabletting machinery, but the machinery may be heated in some other way also. If any heat is supplied, it is envisaged that this will be supplied conventionally, such as by passing the particulate composition through an oven, rather than by any application of microwave energy.

The size of a tablet will suitably range from 10 to 160 grams, preferably from 15 to 60 g, depending on the conditions of intended use, and whether it represents a dose for an average load in a fabric washing or dishwashing machine or a fractional part of such a dose. The tablets may be of any shape. However, for ease of packaging they are preferably blocks of substantially uniform cross-section, such as cylinders or cuboids.

The overall density of a tablet for fabric washing preferably lies in a range from 1040 or 1500 g/litre preferably at least 1100 g/litre up to 1400 g/litre. The tablet density may well lie in a range up to no more than 1350 or even 1250 g/litre. The overall density of a tablet of some other cleaning composition, such as a tablet for machine dishwashing or as a bleaching additive, may range up to 1700 g/litre and will often lie in a range from 1300 to 1550 g/litre.

The detergent tablet may be made by a process which comprises mixing said disintegrant granules with the other constituents of the composition, placing a quantity of the resultant particulate composition within a mould, and, compacting the composition within the mould to produce the tablet.

Tablet Testing—Disintegration

The speed of disintegration of the tablets in the examples was measured by means of a test procedure under static conditions in which a pre-weighed tablet was placed on a metal grid with 1×1 cm mazes and the tablet and grid was then immersed in a suitable amount of 15° FH (French Hardness) tap water at 10° C. or 20° C. so that the tablet when immersed is covered by 2cm of water. After 60 seconds the metal grid is carefully taken out of the water and the wet tablet residue is weighed. If the tablet had fully disintegrated in this time then the time taken for 100% disintegration is recorded.

It is preferred that the tablets exhibit 70% or more disintegration in the above test, more preferably 75% or more, most preferably 80% or more.

Tablet Strength

The strength of the tablets, in their dry state as made on the compaction press, can be determined according to their diametrical fracture stress DFS, which is calculated from the equation:

$$DFS = \frac{2 {F}_{max}}{π Dt}$$

where DFS is the diametrical fracture stress in Pascals, Fₘₐₓ is the applied load in Newtons to cause fracture, D is the tablet diameter in metres and t is the tablet thickness in metres. The test is carried out using an Instron type universal testing instrument to apply compressive force on a tablet diameter (i.e. perpendicular to the axis of a cylindrical tablet). It is preferred that tablets have a DFS of at least 20 kPa more preferably at least 25 kPa, such as 30 kPa or above.

Determination of the Water-Swelling Capacity of the Water-Swellable Agent

To demonstrate the water-swelling capacity of the water-swellable agent, 19.6 grams of the agent was blended with 0.4 grams of ultramarine pigment and compressed into a tablet using a laboratory tablet press at about 250 MPa to give a tablet of 32 mm diameter. This was crushed and sieved to give granules of particle size 500-1000 um. A glass tube, 33 mm in internal diameter and about 30 cm long with a sintered porous glass disk (porosity 1) fitted at one end was immersed upright, with said one end lowermost, in a large beaker of water (at 25° C.) so that the water level rose to about 14 cm above the sintered glass. 1 gram of the granules was added to the tube and allowed to settle on the sintered glass disc. With this arrangement water has access to the granules from both above and below. The granules immediately began to swell, forming a jelly-like mass. The ultramarine pigment imparted a blue colour to the mass making it easy to see the end and to record its height. The height of the swelling mass was recorded at intervals and showed an initial rapid rise followed by a level off after about 20-30 minutes. From the diameter of the tube, the volume of the swollen mass can be calculated. The result was expressed as cm³/g water swellable agent after 20 minutes.

It is intended that the tablets, when used as fabric washing tablets in an automatic washing machine, may be added either to the powder dispensing draw, or, directly in to the washing drum. This may occur either manually or automatically.

The detergent/cleaning tablets of the invention are suitable for use in what is known in the art as ‘homecare’ applications. That is, detergent tablets which are suitable for use in cleaning and maintenance operations typically carried out around the home. It does not include operations carried out directly on a human or animal body which are known as ‘personal care’ applications. Examples of ‘homecare’ detergent tablets include; laundry tablets, (machine) dishwashing tablets, hard-surface cleaning tablets, toilet-cleaning tablets, bleaching tablets, water-softening tablets etc.

### EXAMPLES (Part 1)

The invention will be further described by reference to the following examples. Further examples within the scope of the present invention will be apparent to the person skilled in the art.

Preparation of a Stock Granulated Powder

A stock granular detergent powder was made by granulating the ingredients above the entry “post-dosed ingredients” under high shear followed by densification under reduced shear to produce a granulated component. The post-dosed ingredients were then added as described above under the heading “Granulation Process” to produce a detergent powder of the overall composition in table 1.

TABLE 1
Stock detergent powder composition

| Ingredient; | % wt |
|---|---|
| Sodium linear alkylbenzene sulphonate | 12.34 |
| C₁₃₋₁₅ fatty alcohol 7E0, branched. | 3.53 |
| C₁₃₋₁₅ fatty alcohol 3E0, branched | 1.89 |
| Soap | 0.94 |
| Zeolite*¹ (anhydrous) | 27.60 |
| Sodium acetate trihydrate/zeolite blend | 3.53 |
| (99:1 wt mixture) | |
| Sodium carbonate | 4.10 |
| Sodium carboxymethyl cellulose | 0.55 |
| (69% wt active) | |
| Salts, moisture and NDOM*² | 4.97 |
| POST-DOSED INGREDIENTS; | |
| Fluorescer adjunct | 2.17 |
| SOKALAN ™ HP23 adjunct*³ | 1.45 |
| Sodium citrate dihydrate | 5.07 |
| Tetraacetylethylene diamine (TAED) granules, | 5.44 |
| (83% active) | |
| Sodium percarbonate (coated)*⁴ | 20.30 |
| Sodium silicate granules (80% active) | 4.35 |
| EDTMP granulate (DEQUEST ™ 2047)*⁵ | 1.04 |
| EHDP granulate (DEQUEST ™ 2016)*⁶ | 0.73 |
| TOTAL | 100% by |
| | weight |

*¹‘DOUCIL ™ A24’, is a maximum aluminium zeolite P (MAP) ex Ineos Silcas, UK.
*²NDOM is non detergent organic matter
*³SOKALAN ™ HP23 is a grafted co-polymer of polyethylene oxide and polyvinylacetate ex BASF, Germany.
*⁴Coated percarbonate ex Interox
*⁵DEQUEST ™ 2047 is ethylene diamine tetra methylene phosphonate ex Monsanto
*⁶DEQUEST ™ 2016 is ethylene hydroxy diphosphonate ex Monsanto.

Disintegrant Granules A to F

Six disintegrant granules were prepared by the typical preparative method described above under the heading “Disintegrant granules”. The granules had the compositions given in table 2 and were sieved to collect the fraction having a particle size of 500 to 1200 um unless otherwise stated. The amounts given in Table 2 are the percentages of each ingredient by weight in the disintegrant granule and add up to 100% by weight based on the total weight of the granule. Ac-Di-Sol™ is the water-swellable agent.

TABLE 2
Disintegrant granule compositions

| | A | B | C | D | E | F |
|---|---|---|---|---|---|---|
| | % wt | % wt | % wt | % wt | % wt | % wt |
| Zeolite | 46.25 | 82.5 | 72.25 | 59.25 | 33.25 | 20.25 |
| P*¹ | | | | | | |
| Water | 46.25 | 10 | 20.25 | 33.25 | 59.25 | 72.25 |
| swelling | | | | | | |
| clay*⁷ | | | | | | |
| Ac-Di- | 7.5 | 7.5 | 7.5 | 7.5 | 7.5 | 7.5 |
| Sol ™*⁸ | | | | | | |

*⁷Brebent clay, a water-swelling calcium-form bentonite clay which has been treated with sodium carbonate and which is sold under the name BREBENT ™ ex Laporte PLC.
*⁸Cross-linked carboxymethyl cellulose ex FMC Corporation, USA.

### Comparative Examples C1 To C5

Comparative examples C1 to C5 were produced having the composition as shown in table 3.

TABLE 3
comparative examples C1 to C5.

| | C1 | C2 | C3 | C4 | C5 |
|---|---|---|---|---|---|
| | % wt | % wt | % wt | % wt | % wt |
| Stock composition of | 100 | 90 | 90 | 90 | 90 |
| table 1 | | | | | |
| Granular water | — | — | 10 | — | — |
| swelling clay*⁷ | | | | | |
| Granular zeolite*¹ | — | 10 | — | — | — |
| Granule; 92.5 parts | — | — | — | — | 10 |
| clay*⁷:7.5 parts | | | | | |
| AC-Di-Sol ™*⁸ | | | | | |
| Granule; 92.5 parts | — | — | — | 10 | — |
| zeolite*¹:7.5 parts | | | | | |
| AC-Di-Sol ™*⁸ | | | | | |

40 g portions of each comparative composition were made into cylindrical tablets of 44.5 mm diameter and height 18-22 mm using a Graseby Specac laboratory tabletting machine. The compaction pressure used for each tablet was adjusted so that the tablets were all compacted to the same diametrical fracture stress of 30 kPa. The strength of the tablets, in their dry state as made on the press, was determined as their diametrical fracture stress DFS by the method detailed in the description of the invention above.

### Examples 1 and 2

The stock detergent powder of table 1 was mixed with disintegrant granules A and B from table 2 to produce examples 1 and 2 which are examples according to the invention as detailed in table 4.

TABLE 4
preparation of examples 1 and 2.

| | 1 | 2 |
|---|---|---|
| | % wt | % wt |
| Stock composition of table 1 | 90 | 90 |
| Disintegrant granules A | 10 | — |
| Disintegrant granules B | — | 10 |

These compositions were compacted as detailed above for comparative examples C1 etc above.

### Disintegration Results of Comparative Examples C1 to C5 and Examples 1 and 2

The speed of disintegration of the tablets was measured under static conditions as described above under the heading “Tablet testing—disintegration”. The disintegration results are given in table 5. The “initial” result is the disintegration result obtained for tablets made and tested on the same day. The “storage” result is the disintegration result obtained for tablets made and stored at 20° C. in a closed container for 14 days before being tested for disintegration.

TABLE 5
disintegration results of comparative
examples C1 to C5 and examples
1 and 2.

| | Initial % | Storage % |
|---|---|---|
| | disintegration; 60 | disintegration; 60 |
| Example | seconds, 20° C. | seconds, 20° C. |
| C1 | 10% | 8% |
| C2 | 49% | 49% |
| C3 | 27% | 43% |
| C4 | 81% | 48% |
| C5 | 28% | 44% |
| 1 | 65% | 96% |
| 2 | 63% | Not measured |

The above examples show that tablets comprising disintegrant granules comprising the swelling clay, the crystalline aluminosilicate and the water-swellable agent demonstrate good disintegration properties both initially and upon storage. A comparison against C1 and C2 illustrates this point. C4 shows good initial disintegration but this is not maintained upon storage.

### Comparative Example C6

Comparative example C6 was prepared as shown in table 6. The disintegrant granule components are expressed as parts by weight.

TABLE 6
comparative example C6.

| | % wt |
|---|---|
| Stock composition of table 1 | 74 |
| Granule; 92.5 parts clay*⁷:7.5 parts AC-Di-Sol ™*⁸ | 5 |
| Na acetate. 3H₂O/zeolite blend (99:1 wt mix) | 21 |

40 g portions of the compositions were made into cylindrical 5 tablets as detailed above for comparative examples C1 etc.

### Examples 3 to 6

The stock detergent powder of table 1 was mixed with disintegrant granule A of table 2, and where stated in table 7 additional sodium acetate/zeolite blend to produce examples 3 to 6. These are examples according to the invention.

TABLE 7
preparation of examples 3 to 6.

| | 3 | 4 | 5 | 6 |
|---|---|---|---|---|
| | % wt | % wt | % wt | % wt |
| Stock composition | 90 | 90 | 85 | 85 |
| of table 1 | | | | |
| Disintegrant | — | 10 | — | 10 |
| granule A | | | | |
| Na acetate. | — | — | 5 | 5 |
| 3H₂O/zeolite | | | | |
| blend (99:1 wt mix) | | | | |

These compositions were compacted as detailed above for comparative examples C1 etc above.

Disintegration Results of Comparative Example C6 and Examples 3 to 6.

The speed of disintegration of the tablets was measured under static conditions as described under the heading “Tablet testing—disintegration”. The disintegration results are given in table 8.

TABLE 8
disintegration results of comparative
examples C6 and Examples 3 to 6.

| | Initial % disintegration; |
|---|---|
| Example | 60 seconds, 20° C. |
| C6 | 100% |
| 3 | 57% |
| 4 | 73% |
| 5 | 84% |
| 6 | 91% |

C6 shows excellent disintegration but requires 21% by weight of a disintegration promoting particle material plus 5% by weight of a disintegrant granule. The tablets according to the invention also show acceptable disintegration but at much lower total levels of disintegration promoting particle material and disintegrant granule. This allows greater amounts of the ‘stock’ composition to be used in the tablets. The additional improvement in disintegration obtained by including a disintegration promoting particle material in the composition in addition to the disintegrant granule can be seen by comparing the results obtained for examples 3, 5, 4 and 8.

### Comparative Example C7

Comparative example C7 was produced as shown in table 9. The granule components are expressed as parts by weight.

TABLE 9
comparative example C7.

| | % wt |
|---|---|
| Stock composition | 90 |
| of table 1 | |
| Granule; 92.5 parts zeolite*¹: | 5 |
| 7.5 parts AC-Di-Sol ™*⁸ | |
| Na acetate. 3H₂O/zeolite blend | 5 |
| (99:1 wt mix) | |

40 g portions of the composition were compacted as detailed above for examples etc.

### Examples 7 to 14

The stock detergent powder of table 1 was mixed with disintegrant granules A and C to F, and where stated additional sodium acetate/zeolite blend to produce examples 7 to 14 which are examples according to the invention as detailed in table 10.

TABLE 10
preparation of examples 7 to 14.

| | 7 | 8 | 9 | 10 | 11 | 12 | 13 | 14 |
|---|---|---|---|---|---|---|---|---|
| | % wt | % wt | % wt | % wt | % wt | % wt | % wt | % wt |
| Stock | 90 | 90 | 90 | 90 | 90 | 85 | 77 | 70 |
| composition of | | | | | | | | |
| table 1 | | | | | | | | |
| Disintegrant | 5 | — | — | — | — | — | — | — |
| granule A | | | | | | | | |
| Disintegrant | — | 5 | — | — | — | — | — | — |
| granule C | | | | | | | | |
| Disintegrant | — | — | 5 | — | — | 5 | 5 | 5 |
| granule D | | | | | | | | |
| Disintegrant | — | — | — | 5 | — | — | — | — |
| granule E | | | | | | | | |
| Disintegrant | — | — | — | — | 5 | — | — | — |
| granule F | | | | | | | | |
| Na acetate. | 5 | 5 | 5 | 5 | 5 | 10 | 18 | 25 |
| 3H₂O/zeolite | | | | | | | | |
| blend (99:1 | | | | | | | | |
| wt mix) | | | | | | | | |

These compositions were compacted as detailed above for comparative examples C1 etc.

Disintegration Results of Comparative Examples C7 and Examples 7 to 14.

The speed of disintegration of the tablets was measured under static conditions as described under the heading “Tablet testing—disintegration”. The disintegration results are given in table 11.

TABLE 11
disintegration results of comparative
examples C7 and Examples 7 to 14.

| | Initial % disintegration; 60 |
|---|---|
| Example | seconds, 20° C. |
| C7 | 42% |
| 7 | 67% |
| 8 | 74% |
| 9 | 79% |
| 10 | 63% |
| 11 | 50% |
| 12 | 90% |
| 13 | 100% in 45 seconds |
| 14 | 100% in 32 seconds |

The tablets according to the invention show good disintegration compared to a tablet comprising a disintegrant granule which comprised zeolite but no clay.

### Examples 15 to 17

The stock detergent powder of table 1 was mixed with disintegrant granule b and additional sodium acetate/zeolite blend to produce examples 15 to 17 which are examples according to the invention as detailed in table 12.

TABLE 12
preparation of examples 15 to 17.

| | 15 | 16 | 17 |
|---|---|---|---|
| | % wt | % wt | % wt |
| Stock composition of table 1 | 90 | 90 | 90 |
| Disintegrant granule B; particle | 5 | — | — |
| size 500-1200 um | | | |
| Disintegrant granule B; particle | — | 5 | — |
| size 500-710 um | | | |
| Disintegrant granule B; particle | — | — | 5 |
| size 710-1200 um | | | |
| Na acetate. 3H₂O/zeolite | 5 | 5 | 5 |
| blend (99:1 wt mix) | | | |

These compositions were compacted as detailed above for comparative examples C1 etc above.

Disintegration Results of Examples 15 to 17.

The speed of disintegration of the tablets was measured under static conditions as described under the heading “Tablet testing—disintegration”. The disintegration results are given in table 13.

TABLE 13
disintegration results of Examples 15 to 17.

| | Initial % disintegration; |
|---|---|
| Example | 60 seconds, 20° C. |
| 15 | 80% |
| 16 | 43% |
| 17 | 62% |

The results show that the particle size of the disintegrant granule can affect the disintegration result obtained for the tablet.

### Examples 18 and 19

Two examples were prepared which comprised additional minor ingredients normally found in detergent tablets. The stock detergent powder of table 1 was mixed with disintegrant granule A and additional sodium acetate/zeolite blend, and the additional minor ingredients to produce examples 18 and 19 which are examples according to the invention as detailed in table 14.

TABLE 14
preparation of examples 18 and 19.

| | 18 | 19 |
|---|---|---|
| | % wt | % wt |
| Stock composition of table 1 | 85.78 | 82.40 |
| Disintegrant granule A | 4.90 | 5.00 |
| Antifoam | 1.96 | 2.00 |
| Lipolase 100 T | — | 0.1 |
| Savinase 12 T | — | 0.5 |
| PEG 1500 powder | 1.96 | — |
| Perfume | 0.49 | — |
| Na acetate. 3H₂O/zeolite | 4.90 | 10.00 |
| blend (99:1 wt mix) | | |

These compositions were compacted as detailed above for comparative examples C1 etc.

Disintegration Results of Examples 18 and 19.

The speed of disintegration of the tablets was measured under static conditions as described under the heading “Tablet testing—disintegration”. The disintegration results are given in table 15.

TABLE 15
disintegration results of Examples 18 and 19.

| | Initial % disintegration; |
|---|---|
| Example | 60 seconds, 20° C. |
| 18 | 46% |
| 19 | 86% |

Procedures and Tests Used in the Examples that Follow Now.

Detergent Tablet Production

Detergent tablets used in the Examples that follow were produced using a 45 mm diameter die set (stainless steel) in conjunction with a Universal Testing Machine Type No. Z030 from Zwick GmbH, Ulm, Germany. A known quantity, 40-45 g, of the cleaning composition which comprised the compositions mentioned in the Examples below was placed in the die, the die plunger was inserted and the assembly was placed between the platens of the Zwick machine which was operated to apply a predetermined pressure to produce a tablet having a defined density and, in particular, a dimensionally stable and fracture resistant tablet. Tablets thus produced were cylindrical in shape, with a diameter of about 45 mm and a height of about 20 mm. Tablets prepared had strength values in the range 25 to 32 kPa (as determined by the Diametrical Fracture Stress test described below) which are typical values for commercial fabric washing tablets found in the Western European market in 1999-2000.

Determination of Diametrical Fracture Stress

The method measures the strength of a detergent tablet using a Zwick Universal Testing Machine Type No. Z030 from Zwick GmbH, Ulm, Germany. The test determines the maximum force required to break the tablet in Newtons. The Diametrical Fracture Stress (DFS) is calculated using this resultant force and the dimensions of the tablet.

The exact dimensions of the tablet to be tested are measured using callipers and the tablet is placed between the platens of the Zwick Universal Testing Machine so that the machine will apply a force along the diameter of the tablet. The force required to break the tablet is then recorded using the following machine settings:

50 kN measuring head and platens.

Hard stops positioned at 375 mm and 1500 mm.

LE position 48 mm (or adjusted appropriately if measured diameter of tablet differs from 45 mm).

Approach Speed of platens under test 10 mm/min.

The Diametrical Fracture Stress is calculated from this force using the equation

$$DFS = \frac{2 {F}_{max}}{π Dt}$$

where DFS is the diametrical fracture stress in Pascals, Fₘₐₓ is the applied load in Newtons to cause fracture, D is the tablet diameter in metres and t is the tablet thickness in metres.

Determination of Tablet Disintegration Profile

Method 1 (Dynamic)

The tablet disintegration profile provides an indication of the extent to which various tablets (e.g. different compositions, different densities) disintegrate under the defined conditions.

4500 g of demineralised water at 20° C. were added to a 5 litre vessel fitted with pH, conductivity and temperature probes and maintained at a constant temperature of 20° C. by immersion in a water bath. The tablets to be tested were inserted into a metal cage having the dimensions 9 cm×4.7 cm×2.7 cm and having 16 apertures (each about 2 mm square) per cm2. The metal cage was attached to the shaft of an overhead stirrer (Heidolph/Janke and Kunkel stirrer) to allow it and its contents to be rotated while immersed in the demineralised water. Prior to testing, the empty cage was immersed in the demineralised water and rotated at 80 rpm for a short period of time until the temperature of the demineralised water as detected by the temperature probe had stabilised at 20±0.2° C. At this time, the conductivity, pH and temperature values registered by the respective probes were recorded. The stirrer was then switched off to allow the cage to be raised out of the water so that a pre-weighed detergent tablet to be investigated could be inserted into the cage. The cage was then re-immersed in the demineralised water together with the inserted tablet and the stirrer was switched on to resume rotation of the container at 80 rpm. Measurements of conductivity and pH, initially at 15 second intervals for one minute and thereafter at one minute intervals, were made over a period of 10 minutes after which time the cage was raised out of the demineralised water to allow the residue of the tablet to be removed. The residue was then dried in an oven at 105° C. so that the dry weight of the residue could be calculated as a percentage of the original tablet weight. This procedure was repeated for a number of tablets having different compositions and different densities.

Method 2 (Static)

4500 g of tap water at 20° C. were added to a 5 litre vessel, which was maintained at 20° C. by immersion in a water bath. The tablets to be tested were weighed and inserted into a metal cage 20 cm in diameter with 1 cm² perforations. The cage was lowered into the 5 litre vessel and left for 60 seconds. The cage was then removed from the water, residue of the tablets was placed on an aluminium tray, dried for 24 hrs at 105° C. and weighed to determine the percentage which had not disintegrated.

Determination of Water Swelling Capacity of Water-Swellable Agent

This procedure was identical to the procedure described under Part 1 (Procedures)

Determination of Weight Mean Particle Size

The weight mean particle size of the materials used in this invention is determined using a Malvern Mastersizer model X, with a lens range up to 300 mm RF and MS17 sample presentation unit as diclosed before above.

The invention is illustrated by the following non-limiting examples.

### EXAMPLES (Part 2)

### Example 1

Disintegration profiles were investigated for a number of detergent tablet formulations, all based on a standard detergent base powder having the following composition. This composition is representative of a typical composition used in a European detergent formulation for tablet detergents, but without minor additives, such as perfume.

| Ingredient | % by weight |
|---|---|
| Sodium linear alkylbenzene sulphonate | 12.34 |
| Nonionic surfactant | 5.42 |
| Zeolite¹ (anhydrous) | 27.60 |
| Sodium acetate trihydrate/zeolite blend (99:1 | 3.53 |
| blend) | |
| Sodium carbonate | 4.10 |
| Sodium citrate dihydrate | 5.07 |
| TAED granules (83% active) | 5.44 |
| Sodium percarbonate (coated)² | 20.30 |
| Sodium silicate granules (80% active) | 4.35 |
| Minor ingredients (fluorescer, polymer, | 6.88 |
| sequestrants, etc.) | |
| Salts, moisture and non-detergent organic matter | 4.97 |
| | 100.00 |

¹Doucil A24, a maximum aluminium P zeolite available from INEOS Silicas Ltd. UK
²Coated percarbonate available from Interox.

The detergent powder was blended with 10 per cent by weight amounts of disintegrant granules having different compositions. In each instance, the disintegrant granules comprised a water insoluble inorganic material, in the form of a zeolite, a swelling clay and a water-swellable agent. In the Examples given below, Doucil A24 (Trade Mark) is a P-type zeolite sold by INEOS Silicas Limited of Warrington, UK; Doucil 4A (Trade Mark) is a 4A zeolite obtainable from INEOS Silicas Limited; Brebent is a sodium enriched calcium-form bentonite available from Laporte plc and the water-swellable agent was Ac-Di-Sol, a croscarmellulose sodium available from FMC Corporation, Philadelphia USA.

The different formulations of the disintegrant granules (on a by weight basis) are given in Table 1 below. For comparison, a granule (Granule F) was prepared using only a zeolite and a swelling polymer. All these granules were prepared using a Pek mixer and Alexanderwerk roller compactor as hereinbefore described. Each was classified by sieving to a size range of 500 to 1200 μm.

TABLE 1

| | Wt. % of Ac- | Wt % of | Wt % of |
|---|---|---|---|
| | Di-Sol in | Doucil A24 in | Brebent in |
| Granule Code | granule | granule | granule |
| A | 7.5 | 20.10 | 72.40 |
| B | 7.5 | 33.20 | 59.30 |
| C | 7.5 | 46.25 | 46.25 |
| D | 7.5 | 59.30 | 33.20 |
| E | 7.5 | 72.40 | 20.10 |
| F | 7.5 | 92.50 | 0 |
| (comparative) | | | |

A series of tablets were prepared at a pressure shown in Table 2 below. Tablets 1A to 1F contain 10% by weight of granules A to F respectively, the other 90% being formed from the base detergent powder mentioned above. Table 2 below shows the level of disintegration after immersion in water for these tablets using the experimental protocol described above in Method 2 (Part 2). The measurement of disintegration shows the level of disintegration obtained by subtracting the percentage of undisintegrated residue retained in the ‘cage’ from 100.

TABLE 2

| | Pressure | | | | |
|---|---|---|---|---|---|
| | of | | | | |
| Tablet | formation | Disintegration % after storage | | | |
| Code | (N mm⁻¹) | 0 days | 7 days | 14 days | 28 days |
| 1A | 4.50 | 80 | 87 | 93 | 100 |
| 1B | 4.50 | 75 | 91 | 93 | 96 |
| 1C | 4.50 | 71 | 100 | 96 | 100 |
| 1D | 4.50 | 54 | 79 | 85 | 79 |
| 1E | 4.25 | 41 | 61 | 67 | 75 |
| 1F | 5.00 | 81 | 58 | 48 | 42 |

### Example 2

Detergent tablets were prepared in a similar manner to that described in Example 1 (Part 2) using granules having the compositions given in Table 3 below. The granules were classified to a size range of 500 to 1200 μm.

TABLE 3

| | Wt % Ac-Di- | Wt % Doucil | |
|---|---|---|---|
| | Sol in | A24 in | Wt % Brebent |
| Granule code | Granule | granule | in granule |
| G | 7.50 | 59.30 | 33.20 |
| H | 7.50 | 46.25 | 46.25 |
| I | 7.50 | 33.20 | 59.30 |

A series of tablets were prepared at a pressure shown in Table 4 below. Tablets 2G to 2I contain 5% by weight of granules G to I respectively, the other 95% being formed from a mixture of the base detergent powder mentioned above and sodium acetate (15% by weight of the tablet). The sodium acetate used was 99% by weight sodium acetate trihydrate and 1% by weight zeolite, Doucil A24.

Table 4 below shows the level of disintegration after immersion in water for these tablets using the experimental protocol described above in Method 2 (Part 2). The measurement of disintegration shows the level of disintegration obtained by subtracting the percentage of undisintegrated residue retained in the ‘cage’ from 100.

TABLE 4

| | Pressure of | Disintegration % after storage | | | | |
|---|---|---|---|---|---|---|
| Tablet | formation | 0 | 2 | 7 | 14 | 28 |
| Code | (N mm⁻²) | days | days | days | days | days |
| 2G | 4.30 | 97 | 89 | 82 | 88 | 87 |
| 2H | 4.25 | 92 | 90 | 90 | 89 | 89 |
| 2I | 4.30 | 92 | 96 | 86 | 83 | 81 |

### Example 3

Tablets were prepared according to the method of Example 2 (Part 2) using Granule C and Granule F. Tablet 3C contained 15% by weight sodium acetate (as in this Example 2) and Tablet 3F contained 20% sodium acetate. The disintegration results are shown in Table 5 below.

TABLE 5

| | Pressure of | Disintegration % after storage | | | | |
|---|---|---|---|---|---|---|
| Tablet | formation | 0 | 2 | 7 | 14 | 28 |
| Code | (N mm⁻²) | days | days | days | days | days |
| 3C | 4.30 | 100 | 95 | 80 | NA | NA |
| 3F | 4.25 | 92 | 90 | 90 | 89 | 89 |
| (compara- | | | | | | |
| tive) | | | | | | |

NA = Not available

### Example 4

Granules were prepared using a Pek mixer and Alexanderwerk roller compactor as hereinbefore described. Each was classified by sieving to a size range of 500 to 1200 μm. Granule J was prepared using Doucil A24 and Granule K was prepared using Doucil 4A, a zeolite A available from INEOS Silicas Ltd., Warrington, UK. Each contained 50% by weight zeolite and 50% by weight Brebent clay.

Tablets were prepared according to the method of Example 2 (Part 2) using these granules and containing 10% by weight sodium acetate (as in this Example 2). The disintegration results are shown in Table 6 below.

TABLE 6

| | Pressure of | | | | |
|---|---|---|---|---|---|
| Tablet | formation | Disintegration % after storage | | | |
| Code | (N mm⁻²) | 0 days | 7 days | 14 days | 28 days |
| 4J | 3.7 | 57 | 63 | 61 | 72 |
| 4K | 3.7 | 33 | 47 | 53 | 63 |

### Example 5

Example 4 (Part 2) was repeated except that the granules were incorporated in the tablets at 5% by weight and the amount of sodium acetate (as in Example 2 of Part 2) used in the tablets was 15% by weight. The disintegration results are shown in Table 7 below.

TABLE 7

| | Pressure of | Disintegration % after storage | | | | |
|---|---|---|---|---|---|---|
| Tablet | formation | 0 | 2 | 7 | 14 | 28 |
| Code | (N mm⁻²) | days | days | days | days | days |
| 5J | 4.2 | 83 | 81 | 82 | 76 | 76 |
| 5K | 4.2 | 79 | 67 | 64 | 63 | 63 |

1. A process for the preparation of a disintegrant, suitable for use in a composition in the form of a moulded body, comprising forming by a dry granulation process a granular composition comprising a swelling clay and a water insoluble inorganic material.

2. A process for the preparation of a disintegrant, suitable for use in a composition in the form of a moulded body, comprising forming by a dry granulation process a granular composition comprising a swelling clay, a water insoluble inorganic material and a water-swellable agent which, in its anhydrous state, comprises no more than 20 per cent of the combined weight of said swelling clay, said water insoluble material and said water-swellable agent.

3. A process according to claim 1 or 2 characterised in that the dry granulation process comprises blending ingredients of the granular composition in a mixer followed by roller compaction of the mixture so produced.

4. A process according to claim 1 or 2 characterised in that the roller pressure during roller compacting is in the range 8 to 25 MPa.

5. A process according to claim 1 or 2 characterised in that the granules are screened to a size in the range 500 to 3000 μm.

6. Disintegrant granules, said granules comprising a water swelling clay, a water insoluble inorganic material and a water-swellable agent which, in its anhydrous state, comprises no more than 20 per cent of the combined weight of said water swelling clay, said water insoluble inorganic material and said water-swellable agent.

7. Granules according to claim 6 characterised in that the water-swellable agent is present in an amount comprising no more than 7.5 per cent of the combined weight of said swelling clay, said water insoluble inorganic material and said water-swellable agent.

8. Granules according to claim 6 characterised in that the water-swellable agent is present in an amount comprising at least 1 per cent of the combined weight of said swelling clay, said water insoluble material and said water-swellable agent.

9. Granules according to claim 6 characterised in that the swelling clay is a smectite clay.

10. Granules according to claim 9 characterised in that the smectite clay is a bentonite clay.

11. Granules according to claim 6 characterised in that the water insoluble inorganic material is silica, a material containing at least 70 per cent silica by weight or an aluminosilicate.

12. Granules according to claim 11 characterised in that the water insoluble inorganic material is a crystalline aluminosilicate which is a zeolite having the empirical formula
M_{2/n}O.Al₂O₃.xSiO₂.yH₂O
wherein M represents a metallic cation having a valency of n, x indicates the ratio of atoms of silica to atoms of aluminium and y indicates the ratio of molecules of water to atoms of aluminium.

13. Granules according to claim 12 characterised in that the zeolite is a zeolite P, a zeolite A or a zeolite X.

14. Granules according to claim 12 characterised in that the zeolite is a zeolite P in which M is an alkali metal and x has a value in the range 1.8 to 2.66.

15. Granules according to claim 12 characterised in that zeolite is a zeolite P having a water content in the range 9 to 12 per cent by weight of the zeolite.

16. Granules according to claim 6 characterised in that the relative amounts of swelling clay and crystalline aluminosilicate in the granular disintegrant are in the ratio of 9:1 to 1:9 by weight clay:aluminosilicate.

17. Granules according to claim 6 characterised in that the swelling clay is present in the granules in an amount in the range 20 to less than 50 per cent by weight and the water insoluble material is present in the granules in an amount in the range 35 to 70 per cent by weight.

18. Granules according to claim 6 characterised in that the water-swellable agent has an average primary particle size of up to 600 μm.

19. Granules according to claim 6 characterised in that the water-swellable agent has a water-swelling capacity of at least 5 cm³/g.

20. Granules according to claim 6 characterised in that the water-swellable agent is natural cellulose, cross-linked cellulose, carboxymethyl cellulose, sodium carboxymethyl cellulose, cross-linked sodium carboxymethyl cellulose, pre-gelatinised starch, cross linked starch, or cross linked polyvinyl pyrrolidone.

21. A tablet of compacted particulate detergent composition comprising non-soap surfactant and detergency builder, wherein the tablet or a discrete region thereof comprises disintegrant granules comprising a water-swelling clay, a water-insoluble inorganic material and a water-swellable agent.

22. A tablet according to claim 21 wherein the water-swellable agent in its anhydrous state, comprises no more than 20% by weight of the combined weight of the water-swelling clay, the water-insoluble inorganic material and the water-swellable agent.

23. A tablet according to claim 21 wherein the water-swelling clay is a smectite clay.

24. A tablet according to claim 23 wherein the smectite clay is a bentonite clay.

25. A tablet according to claim 24 wherein the bentonite clay is produced by treating calcium-form bentonite with a compound of sodium.

26. A tablet according to claim 21 wherein the water-insoluble inorganic material is silica, a material containing at least 70% silica by weight or an aluminosilicate.

27. A tablet according to claim 26 wherein the aluminosilicate is a zeolite having the empirical formula;
M_{2/n}O.Al₂O₃xSiO_{2.y}H₂O
wherein M represents a metallic cation having a valency of n, x indicates the ratio of atoms of silica to atoms of aluminium and y indicates the ratio of molecules of water to atoms of aluminium.

28. A tablet according to claim 27 wherein the zeolite is a zeolite P or zeolite A.

29. A tablet according to claim 28 wherein the zeolite is zeolite P in which M is an alkali metal cation and x has a value in the range of from 1.8 to 2.66.

30. A tablet according to claim 27 wherein the zeolite is a zeolite P having a water content in the range of from 9 to 12% by weight.

31. A tablet according to claim 27 wherein the zeolite P is a maximum aluminium zeolite P.

32. A tablet according to claim 21 wherein the relative amount of the water-swelling clay and the water-insoluble inorganic material in the disintegrant granule is in the weight ratio range of from 2:1 to 1:4 by weight of the water-swelling clay: water-insoluble inorganic material.

33. A tablet according to claim 21 wherein the water-swellable agent is selected from the group consisting of cellulose, cross-linked cellulose, carboxymethyl cellulose, sodium carboxymethyl cellulose, cross-linked sodium carboxymethyl cellulose, pre-gelatinised starch, cross-linked starch and cross-linked polyvinyl pyrrolidone.

34. A tablet according to claim 33 wherein the water-swellable agent is a cross-linked sodium carboxymethyl cellulose.

35. A tablet according to claim 21 wherein the water-swellable agent comprises in its anhydrous state 1 to 8% by weight of the combined weight of the swelling clay, water-insoluble inorganic material and the water-swellable agent.

36. A tablet according to claim 21 wherein the water-swellable agent in the disintegrant granule is present in an amount of less than 2% by weight based on the total weight of the tablet composition.

37. A tablet according to claim 21 wherein the water swellable agent has an average primary particle size of up to 600 um.

38. A tablet according to claim 21 wherein the water-swellable agent has a water-swelling capacity of at least 5 cm³/gram.

39. A tablet according to claim 21 wherein the tablet contains from 1 to 15% by weight of the disintegrant granules based on the total weight of the tablet composition.

40. A tablet according to claim 21 wherein the disintegrant granules have a mean particle size in the range of from 700 to 1200 micrometers.

41. A tablet according to claim 21 comprising disintegrant granules comprising a bentonite clay produced by treating calcium-form bentonite with a compound of sodium, maximum aluminium zeolite P and a cross-linked sodium carboxymethyl cellulose.

42. A tablet according to claim 21 wherein the disintegrant granule comprises 20 to 45% by weight of the water-swelling clay, 45 to 70% by weight of the water-insoluble inorganic material and 3 to 9% by weight of the water- swellable agent based on the weight of the disintegrant granule.

43. A tablet according to claim 21 which further comprises water-soluble disintegration-promoting particles containing at least 40%, by weight of the particles, of one or more materials selected from the group consisting of;
i) compounds with water-solubility exceeding 50 grams per 100 grams water at 20° C., and
ii) sodium tripolyphosphate containing at least 50% of its own weight of the phase I anhydrous form, and
iii) sodium tripolyphosphate which is partially hydrated so as to contain water of hydration in an amount which is at least 0.5% by weight of the sodium tripolyphosphate in the particles.

44. A tablet according to claim 43 wherein the compounds with water-solubility exceeding 50 grams per 100 grams water at 20° C. are selected from sodium acetate, sodium citrate dihydrate or urea.

45. A tablet according to claim 44 wherein the sodium acetate comprises sodium acetate trihydrate.

46. A tablet according to claim 43 wherein the water-soluble disintegration-promoting particles are present in an amount of from 5% to 25% by weight based on the total weight of the composition.

47. A process for making a tablet of compacted particulate detergent composition comprising non-soap surfactant and detergency builder, the process comprising mixing disintegrant granules comprising a water-swelling clay, a water-insoluble inorganic material and a water swellable agent with the other constituents of the detergent composition to produce a particulate detergent composition, placing a quantity of the resultant particulate detergent composition within a mould, and, compacting the composition within the mould to produce the tablet.
